(19) United States
(12) Patent Application Publication
(10) Pub. No.: US 2008/0138527 A1
(43) Pub. Date: Jun. 12, 2008

(54) Method for producing multi layered coating film

(76) Inventors: Koji Okuma, Aichi (JP); Hiroyuki Mizuno, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 11/907,379

(22) Filed: Oct. 11, 2007

(30) Foreign Application Priority Data
Oct. 13, 2006 (JP) 2006-280231

(51) Int. Cl. B05D 3/02; C08G 63/91

(52) U.S. Cl. 427/385.5; 525/418

(57) ABSTRACT

The present invention relates to an intermediate coating composition, which comprises
(a) a polyester resin comprising a polyester resin (i) and a polyester resin (ii),
(b) a bisphenol type epoxy resin, and
(c) an imino group-containing melamine resin, each of which contents of the components (a), (b) and (c) is relative to weight of the resin solid contents in the composition,
   wherein
a weight ratio of the polyester resin (a)/the imino group-containing melamine resin (c) [(a)/(c)] is within a range of 50/50 to 70/30.

Therefore, the present invention can provide an intermediate coating composition which can form a multi layered coating film having an excellent chipping resistance, as well as, a method for producing a multi layered coating film by using the intermediate coating composition.

### TECHNICAL FIELD

The present invention relates to an intermediate coating composition, which can provide a multi layered coating film having an excellent chipping resistance, as well as a method for producing a multi layered coating film.

### BACKGROUND OF THE INVENTION

One of properties required for a coating film applied on an exterior body panel of a vehicle body is an excellent chipping resistance. Herein, “chipping” means a phenomenon associated with a coating film wherein the coating film is partially peeled off with an impact caused by a collision between the coating film and an object, such as small stones and gravels, which is resulted from rotation of tires of a vehicle. The chipping can provide problems associated with the appearance of the coating film, such as exposure of an intermediate coating film and/or an undercoating film under the coating film, each of which has a different color from that of the top coating film. The chipping further provides problems associated with corrosion appeared on the exterior body panel surface of the vehicle body. The corrosion is caused by penetration of moisture under the coatings trough the chipped area. Under such circumstances, particularly in the cold regions wherein a large amount of salts, small stones and gravels, are diffused on roads in order to melt snow in winter, there are frequent collisions between a coating film on an exterior body panel of a vehicle body and objects such as gravels. Therefore, it is desired to provide a coating film having a superior excellent chipping resistance in the art.

The coating film applied on the vehicle body generally includes an intermediate coating film wherein chipping resistance is improved. For example, JP-A-2002-348532 (corresponding to U.S. Pat. No. 6,787,190) (Patent Literature 1) discloses a water based paint composition comprising

(a) a polyurethane resin obtained by:

(i) performing a urethanation reaction between a polyisocyanate and a polyalkylene glycol; and

(ii) reacting the isocyanate-containing prepolymer formed in step (i) with a monohydric alcohol having at least 5 carbon atoms; and

(b) a water-soluble organic solvent having a boiling point which is not higher than 150° C. This patent literature 1 disclosed that the application of the water based paint composition can provide improved properties such as chipping resistance and corrosion resistance of the multi layered coating film comprising a cation electrodeposition coating film, the intermediated coating film and top coating film(s).

JP-A-2003-181368 (Patent Literature 2) discloses a method for producing a multi layered coating film, which includes steps of:

applying a first color base coating composition (A), a second color base coating composition (B) and a clear coating composition (C) by wet-on-wet application to give a three layered coating film, and

heating, crosslinking and curing the three layered coating film at once,

wherein the cured coating film formed with the first color base coating composition (A) has a Young's modulus (a) of no less than 3000 MPa at −20° C. and a breaking energy (b) of no less than 2×10⁻³ J.
This patent literature 2 also discloses that the coating film formed with the first color base coating composition (A) has properties such as an adhesion strength (d) of 13 to 18 N between the resulting coating film and the undercoat film. The object of the invention disclosed in the literature consists in a development of a coating composition which can provide a good chipping resistance and which can be applied to the 3C1B (i.e., three coat and one bake) method for producing a multi layered coating film.

JP-A-6-254482 (Patent Literature 3) discloses a coating method in a 4 coat 1 bake manner, which employs a coating composition providing chipping resistance. The coating composition essentially includes a urethane modified polyester resin (A), a blocked polyisocyanate compound (B), a melamine resin (C), an epoxy resin (D) and a pigment (E). The coating method is characterized in an application of the coating composition providing chipping resistance wherein the content of the component (E) is 200 to 300% by weight relative to the total amount of the components (A) to (D), and the content of the component (E) is 43 to 75% volume relative to the volume of the cured coating film of the coating composition. The patent literature 3 discloses that a multi layered coating film having a good chipping resistance can be formed.

JP-A-9-176571 (Patent Literature 4) discloses an intermediate coating composition essentially including a hydroxyl group-containing polyester resin (A), a melamine resin (B), an epoxy group-containing acrylic resin (C), and a blocked polyisocyanate compound (D). This patent literature discloses that the intermediate coating composition can form a coating film having good properties such as interlayer adhesion and chipping resistance.

JP-A-10-202185 (Patent Literature 5) discloses a method for forming a coating film, which includes steps, in the following order:

(1) forming an electrodeposition coating film on a substrate;

(2) forming a intermediate coating film having a cured thickness of 15 to 25 μm with a coating composition essentially comprising a polyester resin (a), a melamine containing a butylated melamine and/or a methyl-butyl mixed type melamine (b), an epoxy resin (c), and a pigment such as titanium dioxide and barium sulfate (d); and

(3) forming a top coating(s).

This patent literature 5 discloses that the method can provide a thinner coating film without losing the properties for the intermediate coating film, such as hiding ability to an undercoat, chipping resistance, overcoat appearance and gloss.

As described above, there are various inventions to provide an improved chipping resistance for a coating film. At the present, there is no method for producing a coating film having an excellent chipping resistance, in conformity with the requirement, and having all the other properties.

[Patent Literature 1] JP-A-2002-348532 (corresponding to U.S. Pat. No. 6,787,190)

### [Patent Literature 2] JP-A-2003-181368

### [Patent Literature 3] JP-A-6-254482

### [Patent Literature 4] JP-A-9-176571

### [Patent Literature 5] JP-A-10-202185

### DISCLOSURE OF INVENTION

### Problem to be solved by the invention

The present invention can solve the above-described problems in the prior arts. The object of the present invention consists in provision of an intermediate coating composition which can form a multi layered coating film having an excellent chipping resistance, as well as, a method for producing a multi layered coating film by using the intermediate coating composition.

### SUMMARY OF THE INVENTION

The present invention provides an intermediate coating composition, in order to solve the above-described problems, which comprises

(a) 40 to 70% by weight of a polyester resin comprising a polyester resin (i) and a polyester resin (ii),

(b) 2.5 to 12.5% by weight of a bisphenol type epoxy resin, and

(c) 25 to 50% by weight of an imino group-containing melamine resin,

each of which contents of the components (a), (b) and (c) is relative to weight of the resin solid contents in the composition,
wherein

a weight ratio of the polyester resin (a)/the imino group-containing melamine resin (c) [(a)/(c)] is within a range of 50/50 to 70/30, and wherein

the polyester resin (i) has a number average molecular weight of 2000 to 4000, and is prepared by a condensation polymerization of, at least, a polycarboxylic acid component and a polyalcohol component, wherein the polycarboxylic acid component comprises no less than 50% by weight of at least one of polycarboxylic acids selected from the group consisting of aromatic polycarboxylic acids, alicyclic polycarboxylic acids and anhydrides thereof, and

the polyester resin (ii) has a number average molecular weight of 1000 to 2000, and is prepared by a condensation polymerization of, at least, a polycarboxylic acid component and a polyalcohol component, wherein the polycarboxylic acid component comprises no less than 50% by weight of a straight or branched aliphatic polycarboxylic acid or an anhydride thereof.

It is preferable that the bisphenol type epoxy resin (b) has an epoxy equivalent of 500 to 1500 g/eq, and the imino group-containing melamine resin (c) further has an alkyl ether group comprising a methyl group and a butyl group.

The present invention also provides a method for producing a multi layered coating film comprising an intermediate coating film on an article, a base coating film thereon and a clear coating film thereon, which includes steps of

applying an intermediate coating composition on an article, heating and curing to form an intermediate coating film, and

applying a base coating composition and clear coating composition on the cured intermediate coating film, heating and curing to form a multi layered coating film, wherein

the intermediate coating composition comprises

(a) 40 to 70% by weight of a polyester resin comprising a polyester resin (i) and a polyester resin (ii),

(b) 2.5 to 12.5% by weight of a bisphenol type epoxy resin, and

(c) 25 to 50% by weight of an imino group-containing melamine resin,

each of which contents of the components (a), (b) and (c) is relative to weight of the resin solid contents in the composition,
wherein

a weight ratio of the polyester resin (a)/the imino group-containing melamine resin (c) [(a)/(c)] is within a range of 50/50 to 70/30, and wherein the polyester resin (i) has a number average molecular weight of 2000 to 4000, and is prepared by a condensation polymerization of, at least, a polycarboxylic acid component and a polyalcohol component, wherein the polycarboxylic acid component comprises no less than 50% by weight of at least one of polycarboxylic acids selected from the group consisting of aromatic polycarboxylic acids, alicyclic polycarboxylic acids and anhydrides thereof, and

the polyester resin (ii) has a number average molecular weight of 1000 to 2000, and is prepared by a condensation polymerization of, at least, a polycarboxylic acid component and a polyalcohol component, wherein the polycarboxylic acid component comprises no less than 50% by weight of a straight or branched aliphatic polycarboxylic acid or an anhydride thereof.

In the above method, it is preferable that the lowest adhesion strength is within a range of 0.15 to 0.27 kN/m on the coating boundary between the intermediate coating film and the base coating film thereon in the multi layered coating film.

The present invention further provides a multi layered coating film which is obtainable by the above-described method for producing a multi layered coating film.

### EFFECT OF THE INVENTION

The present inventive intermediate coating composition comprises (a) a polyester resin, (b) a bisphenol type epoxy resin and (c) an imino group-containing melamine resin. The polyester resin (a) comprises at least two polyester resins, each of which has an individual property, i.e., polyester resins (i) and (ii). Application of thus prepared intermediate coating composition can provide a formation of an intermediate coating film, which has an excellent chipping resistance in addition to the excellent properties such as corrosion resistance, hiding ability to an undercoat, and surface smoothness, and which has interlayer adhesions between an electrodeposition coating film and the intermediate coating film and between the intermediate coating film and a base coating film. The multi layered coating film according to the present invention affords benefits such as an excellent chipping resistance and an excellent corrosion resistance, etc.

### DETAILED DESCRIPTION OF THE PREFERRED EMBODIMENTS

### Best Mode for Carrying Out the Invention

### Intermediate Coating Composition

The intermediate coating composition according to the present invention comprises (a) a polyester resin, (b) a bisphenol type epoxy resin and (c) an imino group-containing melamine resin. The polyester resin (a) comprises at least two polyester resins (i) and (ii).

### (a) Polyester Resin

The polyester resin (a) can be prepared by a condensation polymerization of, at least, a polycarboxylic acid and/or an anhydride thereof (hereinafter, which are abbreviated as “a polycarboxylic acid component”) and a polyalcohol (hereinafter, which is abbreviated as “a polyalcohol component”). Other reaction component(s) may be added to the condensation polymerization. The other reaction component, as used herein, includes, for example, monocarboxylic acids; hydroxycarboxylic acids; lactones; and drying oils, semidrying oils and nondrying oils and fatty acids thereof; etc.

The polyester resin (i), one of these components of the polyester resin (a), can be prepared by a condensation polymerization of, at least, a polycarboxylic acid component and a polyalcohol component, wherein the polycarboxylic acid component comprises no less than 50% by weight of at least one of polycarboxylic acids selected from the group consisting of aromatic polycarboxylic acids, alicyclic polycarboxylic acids and anhydrides thereof. The polyester resin (i) has a number average molecular weight of 2000 to 4000.

The polyester resin (ii), one of these components of the polyester resin (a), can be prepared by a condensation polymerization of, at least, a polycarboxylic acid component and a polyalcohol component, wherein the polycarboxylic acid component comprises no less than 50% by weight of a straight or branched aliphatic polycarboxylic acid and/or an anhydride thereof. The polyester resin (ii) has a number average molecular weight of 1000 to 2000.

The number average molecular weight (Mn), as used herein, is measured by a gel permeation chromatography (GPC) and is a calculated number average molecular weight based on the molecular weight of polystyrene as a standard.

Herein, the polycarboxylic acid component includes three types of polycarboxylic acids, i.e., straight or branched aliphatic polycarboxylic acids, alicyclic polycarboxylic acids and aromatic polycarboxylic acids, and anhydrides thereof. If an aromatic polycarboxylic acid, an alicyclic polycarboxylic acid or an anhydride thereof is employed as a polycarboxylic acid component to prepare the polyester resin (a), the resulting resin has a so-called “rigid” structure, since each of these acids has a “rigid” structure wherein degree of freedom of the molecular is low. Therefore, this can provide a polyester resin having a “rigid” structure, i.e., a “hard” polyester resin. If a straight or branched aliphatic polycarboxylic acid or an anhydride thereof is employed as a polycarboxylic acid component to prepare the polyester resin (a), the resulting polyester resin has a so-called “soft” structure, since this acid has a “soft” structure wherein degree of freedom of the molecular is high.

The polyester resin (i) has a number average molecular weight of 2000 to 4000, which is considerably high. The polyester resin (i) can be prepared by a condensation polymerization of, at least, a polycarboxylic acid component and a polyalcohol component, wherein the polycarboxylic acid component comprises no less than 50% by weight of at least one of polycarboxylic acids selected from the group consisting of aromatic polycarboxylic acids, alicyclic polycarboxylic acids and anhydrides thereof. Accordingly, the polyester resin (i) has a high molecular weight and a “hard” structure. If the number average molecular weight of the polyester resin (i) is more than 4000, the coating composition may provide a coating film having a poor appearance due to the insufficient smoothness, or the coating composition may have a much adversely higher viscosity upon application thereof.

The polyester resin (ii) has a number average molecular weight of 1000 to 2000, which is considerably low. The polyester resin (ii) can be prepared by a condensation polymerization of, at least, a polycarboxylic acid component and a polyalcohol component, wherein the polycarboxylic acid component comprises no less than 50% by weight of a straight or branched aliphatic polycarboxylic acid and/or an anhydride thereof. Accordingly, the polyester resin (ii) has a low molecular weight and a “soft” structure. If the number average molecular weight of the polyester resin (ii) is less than 1000, the coating composition may provide a coating film without an sufficient curability.

As described above, the polyester resin (a) in the intermediate coating composition according to the present invention comprises at least two polyester resins, each of which has an individual property, i.e., polyester resins (i) and (ii). These two polyester resins (i) and (ii) contained in the polyester resin (a) contribute to a formation of an intermediate coating film having an excellent chipping resistance in addition to the coating properties required for the intermediate coating film. As described above, the present inventive intermediate coating composition comprises (a) a polyester resin, (b) a bisphenol type epoxy resin and (c) an imino group-containing melamine resin, wherein the polyester resin (a) comprises at least two polyester resins (i) and (ii). Application of the coating composition can provide a formation of an intermediate coating film, which has an excellent chipping resistance in addition to the excellent properties such as corrosion resistance, hiding ability to an undercoat, and surface smoothness, and which has interlayer adhesions between an electrodeposition coating film and the intermediate coating film and between the intermediate coating film and a base coating film.

The polyester resin (a) in the intermediate coating composition according to the present invention comprises the polyester resins (i) and (ii) in a weight ratio of the polyester resin (i)/the polyester resin (ii) within a preferable range of from 2/1 to 1/2 [(i)/(ii)]. If the polyester resins (i) and (ii) are contained in the polyester resin (a) within the above range, there are benefits that the resulting intermediate coating film has chipping resistance, interlayer adhesions and corrosion resistance in an excellent balance.

Examples of the aromatic polycarboxylic acids and anhydrides thereof for the preparation of the polyester resins (i) and (ii) include phthalic acid, phthalic anhydride, trimellitic acid, trimellitic anhydride, pyromellitic acid, pyromellitic anhydride, isophthalic acid, terephthalic acid, etc. Examples of the alicyclic polycarboxylic acids and anhydrides thereof include tetrahydrophthalic acid, tetrahydrophthalic anhydride, hexahydrophthalic acid, hexahydrophthalic anhydride, methyltetrahydrophathalic acid, methyltetrahydrophthalic anhydride, himic anhydride, etc. Examples of the straight or branched aliphatic polycarboxylic acids and anhydrides thereof include maleic acid, maleic anhydride, fumaric acid, itaconic acid, adipic acid, azelaic acid, sebacic acid, succinic acid, succinic anhydride, dodecenylsuccinic acid, dodecenylsuccinic anhydride, etc.

The polyalcohol component for the preparation of the polyester resins (i) and (ii) includes, for example, but is not particularly limited to, ethylene glycol, diethylene glycol, polyethylene glycol, propylene glycol, dipropylene glycol, polypropylene glycol, neopentyl glycol, 1,2-butanediol, 1,3-butanediol, 1,4-butanediol, 2,3-butanediol, 1,5-pentanediol, 1,6-hexanediol, 1,4-cyclohexanediol, 2,2-dimethyl-3-hydroxypropyl-2,2-dimethyl-3-hydroxypropionate, 2,2,4-trimethyl-1,3-pentanediol, polytetramethyleneether glycol, polycaprolactone polyol, glycerol, sorbitol, annitol, trimethylolethane, trimethylolpropane, trimethylolbutane, hexanetriol, pentaerythritol, dipentaerythritol, etc.

As described above, other component(s) may be added to the polyester resin(s) (i) and/or (ii) in addition to the polycarboxylic acid component and the polyalcohol component. Examples of the other components include monoepoxide compounds such as Cardula E (produced by Shell Chemical Company), lactones, etc. The monoepoxide compounds can introduce a hydroxyl group into the polyester resin, which can improve the interlayer adhesions. A ring-opening addition of the lactone to the polyester prepared from the polycarboxylic acid and the polyalcohol can form a graft chain on the polyester, which can improve the chipping resistance. Specific examples of the lactones include β-propiolactone, dimethylpropiolactone, butyllactone, γ-valerolactone, ε-caprolactone, γ-caprolactone, γ-caprylolactone, δ-valerolactone, δ-caprolactone, etc. The most preferable lactone is ε-caprolactone.

Synthesis of the polyester resins (i) and (ii) can be carried out by a condensation of the above-described reaction components according to conventional procedures and under conventional conditions, for example, heating at 150 to 250° C. for 4 to 10 hours under a nitrogen stream. The condensation can be carried out in the presence of a conventional catalyst which includes dibutyltinoxide, antimony trioxide, zinc acetate, manganese acetate, cobalt acetate, calcium acetate, lead acetate, tetrabutyl titanate, tetraisopropyl titanate, etc. Upon preparing the polyester resin, all the reaction components may be added at once or divided into portions which may be added at several times.

It is preferable that each of the polyester resins (i) and (ii) has a hydroxyl value of 50 to 250 (as a basis of solid contents) and an acid value of 4 to 15 mgKOH/g (as a basis of solid contents). If the hydroxyl value is less than 50, there may be a insufficient curability. If the hydroxyl value is more than 250, there may be an insufficient chipping resistance due to the resulting reduced elasticity. It is more preferable that the hydroxyl value is within a range of 70 to 210 (as a basis of solid contents). If the acid value is less than 4 mgKOH/g, there may be an insufficient curability. If the acid value is more than 15 mgKOH/g, there may be a decreased water resistance. It is more preferable that the acid value is within a range of 5 to 13 mgKOH/g (as a basis of solid contents).

It is preferable that the coating composition according to the present invention comprises the polyester resin (a) comprising the polyester resins (i) and (ii) in a range of 40 to 70% by weigh relative to the weight of the solid resin contents in the composition. If the content is less than 40% by weight, there may be a decreased gloss due to the deteriorated dispersibility. If the content is more than 70% by weight, there may be an insufficient hiding ability to an undercoat. It is more preferable that the content is within a range of 40 to 60% by weight.

### (b) Bisphenol Type Epoxy Resin

The intermediate coating composition according to the present invention comprises a bisphenol type epoxy resin (b). The bisphenol type epoxy resin (b) is preferably a bisphenol A-type epoxy resin. The bisphenol A-type epoxy resin is obtainable by a condensation of a halogenated bisphenol A with epichlorohydrin or β-methyl epihalohydrin, etc.

It is preferable that the bisphenol type epoxy resin (b) has a number average molecular weight within a range of 800 to 2000. If the number average molecular weight is less than 800, there may be insufficient coating properties. If the number average molecular weight is more than 2000, there may be a frequent occurrence of roughness on the resulting coating surface due to the high viscosity of the coating composition.

It is more preferable that the bisphenol type epoxy resin (b) is a bisphenol A-type epoxy resin having a softening point within a range of 70 to 130° C. and an epoxy equivalent within a range of 500 to 1500 g/eq. If the softening point is less than 70° C., the chipping resistance may be decreased. If the softening point is more than 130° C., the smoothness of the resulting coating film may be decreased. If the epoxy equivalent is less than 500 g/eq, the storage stability of the coating composition may be decreased. If the epoxy equivalent is more than 1500 g/eq, the chipping resistance and curability of the coating may be decreased. It is more preferable that the epoxy equivalent is within a range of 550 to 1000 g/eq.

The bisphenol type epoxy resin is commercially available. Examples of the commercially available bisphenol type epoxy resins include Epikote 1007 and Epikote 1010 (available from Yuka Shell Epoxy Co., Ltd.); EPOTOHTO YD-014, EPOTOHTO YD-017, EPOTOHTO YD-019, EPOTOHTO YD-020H, EPOTOHTO YDF2004, PHENOTOHTO YP-50S, EPOTOHTO YD-128, EPOTOHTO YD-172 and EPOTOHTO YD-014U (available from Tohto Kasei Co., Ltd.), etc. The bisphenol type epoxy resin may be used alone or at least two bisphenol type epoxy resins may be used in a combination.

The epoxy resin to be employed in the present invention is not limited to the bisphenol A-type epoxy resin having the above-defined softening point and epoxy equivalent. Therefore, other epoxy resins are available.

Content of the bisphenol type epoxy resin (b) is preferably 2.5 to 12.5% by weight, more preferably 5 to 10% by weight relative to the solid resin content in the composition. If the content is less than 2.5% by weight, the adhesion force between the resulting intermediate coating film and the undercoat film may be decreased. If the content is more than 12.5% by weight, the curability of the coating may be decreased. The present intermediate coating composition contains the bisphenol type epoxy resin (b) within the above-defined range, and therefore it can provide a high adherence to the undercoat film, and provide softness, i.e., an excellent chipping resistance, to the resulting intermediate coating film.

### (c) Imino Group-Containing Melamine Resin

The imino group-containing melamine resin has a partial structure, i.e., melamine structure, as described below:

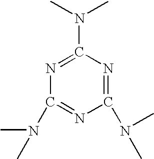

wherein it is preferable that at least one nitrogen atom forms an imino group (i.e., —NH— or ═NH).

The nitrogen (N) atoms attached to the triazine moiety in the above melamine structure may have 6 substituents. The imino group-containing melamine resin, which is also referred to as an imino-type melamine resin, preferably has at least one imino groups formed with the nitrogen atoms. The nitrogen atoms other than the imino group may have other substituent(s) such as —CH₂OH, —CH₂OCH₃, —CH₂OC₃H₇. The melamine resin may be a single nucleus or a polycondensation thereof.

As stated above, the imino group-containing melamine resin contains at least one imino group in the repeating unit (in average). If the imino group-containing melamine resin contains less than one imino group in the repeating unit (in average), the curability and adherence of the resulting coating film may be reduced. If the imino group-containing melamine resin contains unnecessary imino groups, e.g., no less than 3.5 imino groups in the repeating unit (in average), the resulting coating film may have hardness and brittleness, and therefore the coating film may have poor water resistance and poor chipping resistance, which is not preferable.

Examples of the melamine resin having at least one imino group include U-VAN-125 (commercially available from Mitsui Chemicals, Inc., under a product name), U-VAN-225 (commercially available from Mitsui Chemicals, Inc., under a product name), Cymel 254, Cymel 202, Cymel 211, Cymel 325, Cymel 370 and Cymel 327 (commercially available from Mitsui Cytec Industries Inc., under a product name), Mycoat 508 (commercially available from Mitsui Cytec Industries Inc., under a product name), etc.

It is more preferable that the melamine resin (c) is an alkyl ether type melamine resin comprising a methyl group and a butyl group, and yet more preferably both of an methyl ether group and a butyl ether group, as the alkyl ether group, when the applied intermediate coating is cured at a low temperature, e.g., 100 to 130° C.

Content of the imino group-containing melamine resin (c) is preferably 25 to 50, and more preferably 30 to 45% by weight relative to the solid resin contents in the composition. If the content is less than 25% by weight, there may be an insufficient curability. If the content is more than 50% by weight, the resulting coating film may have hardness and brittleness.

It is preferable that a weight ratio of the polyester resin (a)/the imino group-containing melamine resin (c) is within a range of 50/50 to 70/30 [(a)/(c)]. If the content of the polyester resin is more than the upper limit, the hardness may be decreased. If the content of the polyester resin is less than the lower limit, the resulting coating film may have hardness and brittleness, and therefore, the chipping resistance may be reduced. Herein, the weight ratio is based on the weight of the solid contents.

### Pigment

The intermediate coating composition according to the present invention may comprise pigment(s). The pigments which may be comprised in the intermediate coating composition include coloring pigments, such as titanium dioxide, carbon black, barium sulfate, chromium oxide, iron oxide, phthalocyanine and quinacridone; filler pigments, such as talc, calcined kaolin, calcium carbonate and magnesium silicate; luster color pigments, such as aluminum flake, mica, tin flake, gold flake, titanium metal flake and nickel flake; etc. Total content (in parts by weight of the pigment(s) contained in the intermediate coating composition is preferably 25 to 150 parts by weight relative to 100 parts by weight of the solid resin contents in the composition. If the content is less than 25 parts by weight, it may be difficult to ensure the sufficient hiding ability to an undercoat. If the content is more than 150 parts by weight, gloss may be reduced due to the decrease in the dispersibility. It is more preferable that the content is 30 to 120 parts by weight relative to 100 parts by weight of the solid resin contents in the composition.

### Other Components

The intermediate coating composition may further comprise other component(s), in addition to the polyester resin, the bisphenol type epoxy resin and the melamine resin, and if necessary, pigment(s), which component includes thickeners, such as crosslinked resin particles, organic bentonites, fatty acid polyamides and polyethylene waxes; organic solvents, such as aromatic hydrocarbon solvents, aliphatic hydrocarbon solvents, ester solvents and alcohol solvents; additives, such as acid catalysts, ultraviolet (UV) absorbers, hindered amine photo-stabilizers, antioxidants, surface conditioners, leveling agents, pigment dispersing agents, plasticizers and antifoaming agents; etc.

### Preparation of Intermediate Coating Composition

Production method for the intermediate coating composition according to the present invention includes conventional production methods depending on the form of the coating composition. For example, the conventional method includes methods well known to those skilled in the art, which includes

mixing a polyester resin (a), a pigment and a solvent, and, if necessary, a pigment dispersing agent and additional component(s) such as other coating film forming resin to give a pigment dispersed paste,

adding a bisphenol type epoxy resin (b) to the paste, and

adding an imino group-containing melamine resin (c) to the mixture.

Specific examples of the solvents for preparing or diluting the intermediate coating composition include aromatic solvents, such as toluene and xylene; aliphatic solvents, such as hexane, heptane, octane and mineral spirits; ketone solvents, such as methyl ethyl ketone, acetone, methyl isobutyl ketone and cyclohexanone; ether solvents, such as diethyl ether, isopropyl ether, tetrahydrofuran, dioxane, ethyleneglycol dimethyl ether, ethyleneglycol diethyl ether, diethyleneglycol dimethyl ether, diethyleneglycol diethyl ether, propyleneglycol monomethyl ether, anisole and phenetole; ester solvents, such as ethyl acetate, butyl acetate, isopropyl acetate and ethylene glycol diacetate; amide solvents, such as dimethylformamide, diethylformamide, dimethylsulfoxide and N-methylpyrrolidone; cellosolve solvents, such as methyl cellosolve, ethyl cellosolve and butyl cellosolve; alcohol solvents, such as methanol, ethanol and propanol; etc. The solvent may be used alone or two or more solvents may be used in a combination.

Total solid content of the intermediate coating composition according to the present invention upon applying thereof is preferably within a range of 50 to 75% by weight. If the content is less than 50% by weight, viscosity of the resulting composition may be significantly adversely decreased, and therefore, there may be deficiencies in the coating appearance such as inversion and sagging. If the content is more than 75% by weight, viscosity of the resulting composition may be unnecessary increased, and therefore, there may be a poor coating appearance. It is more preferable that the total solid content upon coating is within a range of 55 to 70% by weight.

### Formation of Multi Layered Coating Film

The present method for producing a multi layered coating film comprising an intermediate coating film on an article, a base coating film thereon and a clear coating film thereon includes steps of

applying an intermediate coating composition on an article, heating and curing to form an intermediate coating film, and

applying a base coating composition and clear coating composition, in this order, on the cured intermediate coating film, heating and curing to form a multi layered coating film.

### Article to be Coated

Article to be coated according to the present method for producing a multi layered coating film includes, for example, but is not particularly limited to, metals, plastics and foams thereof, etc. Among others, the present method can advantageously be applied on metals and products thereof such as cast products. The present invention can be particularly preferably applied to metals that can be coated with an electrodeposition coating. Examples of the metals include iron, copper, aluminum, tin and zinc and the like, and alloys containing at least one of these metals. Specific examples of these metal products include bodies and parts for vehicles such as automobiles, tracks, auto-bicycles and buses. More preferably, these metals may be chemically treated with a chemical agent such as phosphate or chromate in advance of an electrodeposition coating. It is preferable that an electrodeposition coating film can be formed on thus chemically treated article. The electrodeposition coating composition includes cationic type and anionic type electrodeposition coating compositions. The cationic type electrodeposition coating composition is preferable because it can provide a coating film superior in the corrosion resistance.

The present method can also be preferably applied to plastics and products thereof. The plastics include polypropylene resins, polycarbonate resins, urethane resins, polyester resins, polystyrene resins, ABS resins, vinyl chloride resins, polyamide resins, etc. The plastic products include molded products e.g., vehicle parts such as spoilers, bumpers, mirror covers, grilles, door knobs, etc. It is more preferable that these plastic molded products can be washed with pure water and/or a neutral detergent in advance of the coating. These plastic molded products may be subjected to a conductive primer coating. The product having a conductive primer coating layer can be subjected to a electrostatic coating.

### Intermediate Coating Film

The intermediate coating composition according to the present invention can be applied on an article, which may be a molded product. The article, if necessary, may have an electrodeposition coating film and/or a primer coating layer. Application of the intermediate coating composition can be achieved by a coating method or a coating apparatus, which depends on a shape of an article to be coated, etc. In the case wherein the intermediate coating composition is applied on an article such as a vehicle body, the coating can be applied, for example, with an air electrostatic spray coating apparatus, e.g., so-called “REACT” or a rotary atomizing electrostatic coating apparatus, e.g., so-called “μμ (micro-micro) bel, “μ (micro) bel”, “meta-bel”, etc. It is preferable that the coating can be applied with a rotary atomizing electrostatic coating apparatus.

Thickness of the cured intermediate coating film is within a preferable range of from about 20 to about 60 μm, and a more preferable range of from about 30 to about 40 μm, but it is not particularly limited.

Subsequently, the applied intermediate coating composition on the article can be heated to give a cured intermediate coating film. Temperature for the heating is generally 100 to 180° C., and more preferably 120 to 160° C. Time for heating is preferably 10 to 30 minutes.

### Multi Layered Coating Film

A base coating composition and a clear coating composition can be applied, in this order, on thus obtained cured intermediate coating film, and subsequently subjected to heating and curing to form a multi layered coating film.

The base coating composition can comprise a coating resin component(s), a curing agent(s) and a coloring pigment(s), and if necessary, a luster color pigment(s) and other component(s). Examples of the coating resin components include an acryl resin, a polyester resin, an alkyd resin, an epoxy rein, an urethane resin, etc. The coating resin component can be employed in a combination with a curing agent including an amino resin and/or a blocked isocyanate resin, etc. A preferable combination is a combination of an acryl resin and/or a polyester resin and a melamine resin from aspects of the pigment dispersibility and handling.

The base coating composition includes a metallic color base coating composition and a solid color base coating composition. The metallic color base coating composition comprises a luster color pigment(s). The solid color base coating composition comprises a coloring pigment(s) and/or a filler pigment(s) in a color such as red, blue and black. The luster color pigment includes, for example, but is not limited to, colored or noncolored metallic luster color materials, such as colored or noncolored metals or alloys, and mixture thereof; interference mica powders; colored mica powders; white mica powders; graphite; and colored or noncolored compressed pigments, etc. A preferable luster color pigment is a colored or noncolored metallic luster color pigment, such as colored or noncolored metals or alloys, and mixture thereof, since it has an excellent dispersibility and can provide a superior transparency for the resulting coating film. Examples of the metals include aluminum, aluminum oxide, copper, zinc, iron, nickel, tin, etc.

The luster color pigment is not particularly limited in any shape, and may be colored. A preferable luster color pigment includes, for example, a flake pigment having an average particle diameter (D₅₀) of 2 to 50 μm and a thickness of 0.1 to 5 μm. Also, the pigment having an average particle diameter within a range of from 10 to 35 μm has an advantage that the pigment is superior in a luster color feeling, and therefore it is used more preferably. The pigment weight concentration (PWC) of the luster color pigment contained in the base coating composition is generally no more than 23.0% by weight. If the pigment weight concentration (PWC) is more than 23.0% by weight, the appearance of the resulting coating film may be deteriorated. The pigment weight concentration (PWC) is preferably 0.01 to 20.0% by weight, and more preferably 0.01 to 18.0% by weight.

The coloring pigment which may be added to the base coating composition includes, for example, those listed in the above description with respect to the intermediate coating composition, etc. In addition, an organic coloring pigment is available. The luster color pigment which may be optionally added to the base coating composition is not particularly limited in any shape and may be colored. A preferable luster color pigment includes, for example, a pigment having an average particle diameter (D₅₀) of 2 to 50 μm and a thickness of 0.1 to 5 μm. Also, the pigment having an average particle diameter within a range of from 10 to 35 μm has an advantage that the pigment is superior in a luster color feeling, and therefore it is used more preferably.

Total pigment weight concentration (PWC), wherein the pigment encompasses the luster color pigment and all the other pigments in the coating composition, is preferably 0.1 to 50%, more preferably 0.5 to 40%, and yet more preferably 1.0 to 30%. If the PWC is more than 50%, the appearance of the resulting coating film may be deteriorated.

As used herein, the term “average particle diameter” for the luster color pigment is usually used to indicate the grain size of the particle (whether the particle diameter is large or small). The average particle diameter as used herein is a value in a median-diameter which is measured by a laser method.

A conventional additive(s) for a coating composition may be further added to the base coating composition employed in the present invention, such as rheology controlling agents, surface conditioners, thickeners, antioxidants, ultraviolet (UV) absorbers, antifoaming agents, etc. Content of the additive(s) is within a conventional range known to those skilled in the art.

Total solid content of the base coating composition employed in the present invention at spraynation is preferably 10 to 60% by weight, and more preferably 15 to 50% by weight. If the content is more than 60% by weight, the appearance of the resulting coating film may be deteriorated due to the excessively increased viscosity. If the content is less than 10% by weight, the appearance of the resulting coating film may be deteriorated due to the excessively decreased viscosity, such as miscibility and ununiformity, etc.

Application of the base coating composition includes the method exemplified in the application of the intermediate coating composition. It is preferable to employ a coating method by an air electrostatic spraying such as multistage coating, and preferably two-stage coating, or a coating method in a combination of an air electrostatic spraying and the rotary atomizing electrostatic coating, in order to increase the design when the base coating composition is applied to an article such as a vehicle body.

Thus prepared base coating composition may be applied on the intermediate coating film on an article, and then a clear coating composition may be applied thereon before baking and/or curing, i.e., on the resulting uncured base coating, to form a multi layered coating film. Herein, the base coating formed with the base coating composition may be subjected to a setting or preheating, and then a clear coating composition may be applied thereon. Generally, the setting includes leaving the coating for 1 to 8 minutes at room temperature. Generally, the preheating includes heating the coating at 40 to 80° C. for 2 to 10 minutes.

A clear coating composition can be applied on thus obtained base coating. The clear coating composition includes, but is not particularly limited to, a coating composition comprising a coating resin component which is thermosetting, and a curing agent. The clear coating composition encompasses various forms such as a solvent type, a waterborne type and a powder type. According to the present method for producing a multi layered coating film, the clear coating film may be formed on the resulting base coating film. The clear coating film may be a protective film, which can smooth the concavo-convex due to the base coating film and absorb poor appearance, which looks like many small powder on the coating surface, due to the base coating film containing a luster color pigment(s), etc.

In the case that the clear coating composition is in a solvent type, a preferable clear coating composition includes a composition in a combination of an acryl resin and/or a polyester resin and an amino resin, or an acryl resin and/or a polyester resin in an epoxy curing system by using a carboxylic acid, etc. These clear coating compositions are preferable from some aspects such as transparency and acid etch resistance.

In the case that the clear coating composition is in a waterborne type, a preferable clear coating composition includes a modified solvent type clear coating composition wherein the coating resin component has been neutralized with a base to give an aqueous resin. The neutralization may be conducted by adding a tertiary amine such as dimethylethanolamine or triethylamine before/after the polymerization.

In the case that the clear coating composition is in a powder type, a preferable clear coating composition includes a conventional powder coating composition such as a thermoplastic or thermosetting powder coating composition. A preferable clear powder coating composition is a thermosetting powder coating composition, which has an advantage that the resulting coating film has excellent properties. The specific thermosetting powder coating composition includes an epoxy-type, acryl-type or polyester-type of the clear powder coating composition, etc. A preferable powder coating composition is an acryl type clear powder coating composition which can provide an excellent weather-resistance. A preferable powder coating composition is a coating composition containing an epoxy-containing acryl resin and/or a polycarboxylic acid, which can provide an excellent appearance with extremely slight yellowing.

A conventional additive(s) for a coating composition may be further added to the clear coating composition employed in the present invention, such as rheology controlling agents, surface conditioners, thickeners, antioxidants, ultraviolet (UV) absorbers, antifoaming agents, etc. Content of the additive is within a conventional range known to those skilled in the art.

Application of the clear coating composition depends on the type of the employed clear coating composition. Specifically, the application includes the method exemplified in the application of the intermediate coating composition.

Thickness of the resulting cured clear coating film formed with the clear coating composition is generally about 10 to about 80 μm, and preferably about 20 to about 60 μm. If the thickness is more than 80 μm, there may be deficiencies such as popping and sagging upon coating. If the thickness is less than 10 μm, the resulting coating unfortunately may profile the ununiformity of the underlying coating.

Thus applied base coating and clear coating thereon, i.e., uncured coatings are simultaneously baked and cured to give cured films. Compared with the separate baking procedures, the present invention has a reduced number of the total procedures and the coating facility has a reduced number of baking/drying equipments. Therefore, it is also preferable in economical and environmental aspects. Setting temperature for curing the base coating and the clear coating at 90 to 180° C., and preferably 120 to 160° C. can provide a cured coating film having a high crosslinking density. If the temperature is more than 180° C., the resulting coating film may have a hardness which renders the film brittle. If the temperature is less than 90° C., insufficient curing may be achieved. Curing time can be varied depending on the curing temperature. The appropriate curing time is 10 to 30 minutes at 120 to 160° C.

Thickness of the multi layered coating film according to the present invention, i.e., total thickness of the intermediate coating film, the base coating film and the clear coating film is preferably 30 to 300 μm, and more preferably 50 to 250 μm. If the thickness is more than 300 μm, the film properties such as thermal cycle test may be decreased. If the thickness is less than 30 μm, the film strength may be decreased.

The multi layered coating film according to the present invention preferably has the lowest adhesion strength within a range of 0.15 to 0.27 kN/m on the coating boundary between the intermediate coating film and the base coating film thereon in the multi layered coating film. The lowest adhesion strength on the coating boundary between the intermediate coating film and the base coating film thereon in the multi layered coating film can be measured according to a SAICAS method. The “SAICAS”, as used herein, means Surface And Interfacial Cutting Analysis System. The SAICAS method can determine peel strength between a coating film and an article to be coated, as well as, shear strength of the coating. Herein, the SAICAS method is a known measuring method to those skilled in the art as described in the “Evaluation of Adhesion Strength of Coated Article by SAICAS Method (1)”, Itsuo Nishiyama, Coating Technology, 34, 4, 123 (1995); “Evaluation of Adhesion Strength of Coated Article by SAICAS Method (2)”, Itsuo Nishiyama, Coating Technology, 34, 5, 129 (1995); etc.

FIG. 1 is a schematic view of a SAICAS method measuring an adhesion strength. A blade 5 is placed on a surface of a coating film 7 formed on an article 9 at a given load, and then horizontally shifted along the surface of the coating film. In this circumstances, the blade 5 is cutting into the coating film 7, which is shown in a cutting direction 11. Once the blade 5 reached to the interlayer of the coating film, the blade 5 is shifted only in a horizontal direction, and then a horizontal scraping stress is measured. An interlayer adhesion strength is calculated according to the formula: P═F_{H}/W

wherein P represents interlayer adhesion strength (N/m), F_{H} represents horizontal scraping stress (N), and w represents blade width (m).

According to the SAICAS method, the interlayer adhesion strength can be measured. This measurement can be applied to a measurement of an interlayer adhesion strength between an intermediate coating film and a base coating film of a vehicle body coating. Such measurement occasionally provides uneven measurement values, since the coating on vehicle body has a higher thickness than that of the general coating. The measurement of the horizontal scraping stress may be adversely effected by the tensile stress of the coating film around the blade edge, and strength of the scraped and rolled upper coating film. Therefore, the interlayer adhesion strength may be affected by these adverse effects.

Herein, more precise measurement of the interlayer adhesion strength is prompted to remove these adverse effects upon measuring due to the surface layer of the coating film and the thickness of the coating film to be scraped. As shown in FIG. 2, a clear coating film 21 and a part of a base coating film 23 are scraped off to remain a coating boundary area between the base coating film 23 and an intermediate coating film 25, in advance of the measurement. The interlayer adhesion strength on the remaining coating boundary can be determined. Herein, a blade is cutting into the scraped area. Once the blade is reached to the boundary between the base coating film and the intermediate coating film, the blade is only horizontally shifted and the horizontal scraping stress is measured (see FIG. 2, wherein scraping is indicated by an arrow). Such measurement is also called as two-step scraping method. In the present invention, the interlayer adhesion strength between the coating films is actually measured by the two-step scraping method. Such measurement of the interlayer adhesion strength can provide an excellent reproducibility.

In the present invention, the “lowest adhesion strength” is determined in addition to the interlayer adhesion strength between the coating films. The “lowest adhesion strength”, as used herein, is the lowest value among the measured values, which is schematically shown in FIG. 3. The adhesion strength of the coating film is generally evaluated according to an “average adhesion strength” which is an average of the measured values for the adhesion strength. According to the present invention, the “lowest adhesion strength” can be determined, since the coating film is actually peeled with an impact, e.g., chipping, at the point wherein the adhesion is the weakest. As described above, the present invention employs the “lowest adhesion strength” between the coating films, which is determined with an excellent reproducibility. The evaluation can be carried out in the most similar circumstances to the actual circumstances wherein there is an occurrence of a coating film peeling, i.e., chipping.

The multi layered coating film according to the present invention has the lowest adhesion strength within a range of 0.15 to 0.27 kN/m on the coating boundary between the intermediate coating film and the base coating film thereon in the multi layered coating film. It is found that the present multi layered coating film is much superior in the chipping resistance. If the lowest adhesion strength is less than 0.15 kN/m, the lowest adhesion strength on the coating boundary between the intermediate coating film and the base coating film is low, and therefore, there may be problems such as a facile peeling on the boundary between the intermediate coating film and the base coating film. If the lowest adhesion strength is more than 0.27 kN/m, the adhesion strength on the coating boundary between the intermediate coating film and the base coating film is high, and therefore, it is difficult for the coating film to be peeled on the boundary between the intermediate coating film and the base coating film, but there may be problems if the film receives an impact, such as frequent peeling on the boundary between the article and the electrodeposition coating film, or between the electrodeposition coating film and the intermediate coating film, e.g., chipping. The chipping on these boundaries can provide a significantly decreased durability for the chipped film. Therefore, the chipping on these boundaries is not preferable, since the chipping enhances the possibility of the occurrence of the corrosion, blisters on the coating film due to the corrosion, and peeling of the coating film. The lowest adhesion strength is within more preferable range of 0.15 to 0.25 kN/m, and particularly preferable range of 0.18 to 0.23 kN/m. The multi layered coating film according to the present invention has the lowest adhesion strength within the above-defined range on the coating boundary between the intermediate coating film and the base coating film, which can provide an excellent chipping resistance and an excellent corrosion resistance.

A method for producing a multi layered coating film according to the present invention employs the intermediate coating composition comprises (a) a polyester resin, (b) a bisphenol type epoxy resin and (c) an imino group-containing melamine resin, wherein a weight ratio of the polyester resin (a)/the imino group-containing melamine resin (c) is within a range of 50/50 to 70/30 [(a)/(c)], and wherein the polyester resin (a) comprises 2 types of polyester resins, i.e., polyester resins (i) and (ii). The intermediate coating composition can provide the lowest adhesion strength within a range of 0.15 to 0.27 kN/m on the coating boundary between the intermediate coating film and the base coating film thereon in the resulting multi layered coating film. The lowest adhesion strength on the coating boundary within the above-defined range can provide superior excellent coating properties such as chipping resistance and corrosion resistance for the resulting multi layered coating film.

### EXAMPLES

The present invention is further described in the following Examples in detail. Those skilled in the art will appreciate that the present invention is not limited to these Examples. In the Examples, “part(s)” and “%” are based on weight unless otherwise specified.

### Preparation Example 1

### Synthesis of Polyester Resin (i)

35.4 Parts of isophthalic acid, 24.9 parts of sebacic acid, 8.4 parts of trimethylolpropane, 28.1 parts of neopentyl glycol, 4.2 parts of Cardula E (glycidyl versatate produced by Shell Chemical Company), 2 parts of dibutyltin oxide were charged into a reaction vessel equipped with a thermometer, a stirrer, a condenser, a nitrogen-introducing tube, a water separator and a rectifying column. The temperature was raised to 210° C. with the proviso that the temperature was raised from 160° C. to 210° C. over 3 hours at a constant rate of the raising temperature. Water as a by-product of the condensation was removed from the reaction system. Once the temperature reached to 210° C., the temperature was maintained for 1 hour. 30 Parts of xylene were gradually introduced into the reaction vessel as a refluxing solvent. The condensation reaction was continued in the presence of the solvent. The reaction mixture was cooled to 150° C. 10.5 Parts of ε-caprolactone were added to the mixture. The temperature was maintained at 150° C. for 2 hours. The reaction mixture was cooled to 100° C. 430 Parts of xylene were added to the mixture to give a varnish containing a polyester resin having a number average molecular weight of 3590, an acid value of 8.5 mgKOH/g (as a basis of solid contents) and a hydroxyl value of 120 mgKOH/g (as a basis of solid contents) (nonvolatile content=70%). The number average molecular weight (Mn) was measured by a gel permeation chromatography (GPC) wherein calibration based on polystyrene molecular weight as a standard was employed.

### Preparation Examples 2 to 5 and Comparison Preparation Examples 1 and 2

### Synthesis of Components Such as Polyester Resins (i) and (ii)

According to the Preparation Example 1, polyester resin was prepared from the starting materials in given amounts listed in the following Table 1. Physical properties of the resulted polyester resin, such as number average molecular weight, are also cited in the following Table 1.

TABLE 1

| | | | | | | Comp. | Comp. |
|---|---|---|---|---|---|---|---|
| | Prep. | Prep. | Prep. | Prep. | Prep. | Prep. | Prep. |
| | Ex. 1 | Ex. 2 | Ex. 3 | Ex. 4 | Ex. 5 | Ex. 1 | Ex. 2 |
| Isophthalic | 35.4 | 25.3 | 30.2 | 21.4 | 27.1 | 24.8 | 38.3 |
| acid | | | | | | | |
| Hexahydro- | | 10.0 | | | | | |
| phthalic | | | | | | | |
| anhydride | | | | | | | |
| Sebacic acid | 24.9 | 24.8 | 29.8 | 32.8 | 27.3 | 35.2 | 21.5 |
| Trimethylol- | 8.4 | 8.4 | 8.4 | | | 8.4 | |
| propane | | | | | | | |
| Trimethylol- | | | | 9.1 | 9.1 | | 9.1 |
| ethane | | | | | | | |
| Neopentyl | 28.1 | 28.0 | 28.2 | 30.7 | 30.8 | 28.0 | 30.8 |
| glycol | | | | | | | |
| Caprolactone | 10.5 | 10.5 | 10.5 | 11.4 | 11.4 | 10.5 | 11.4 |
| Cardula E | 4.2 | 4.2 | 4.2 | 4.5 | 4.6 | 4.2 | 4.6 |
| Polyester | (i) | (i) | (i) | (ii) | (ii) | —* | —* |
| resin type | | | | | | | |
| Number | 3590 | 2690 | 2990 | 1010 | 1020 | 2560 | 1090 |
| average | | | | | | | |
| molecular | | | | | | | |
| weight | | | | | | | |
| Acid value | 8.5 | 8.5 | 8.5 | 8.5 | 8.5 | 8.5 | 8.5 |
| (mgKOH/g) | | | | | | | |
| Hydroxyl | 120 | 120 | 120 | 200 | 200 | 120 | 200 |
| value | | | | | | | |
| (mgKOH/g) | | | | | | | |
| Acid ratio | 58.7:41.3 | 58.7:41.3 | 50.3:49.7 | 39.5:60.5 | 49.8:50.2 | 41.3:58.7 | 64.0:36.0 |
| (rigid acid:soft | | | | | | | |
| acid) | | | | | | | |

*polyester resin for comparison

Isophthalic acid: aromatic polycarboxylic acid (as a rigid acid component)
Hexahydrophthalic anhydride: alicyclic polycarboxylic anhydride (as a rigid acid component)
Sebacic acid: straight aliphatic polycarboxylic acid (as a soft acid component)
Trimethylolpropane: polyalcohol
Trimethylolethane: polyalcohol
Neopenthyl glycol: polyalcohol

### Example 1

### Preparation of Intermediate Coating Composition

70 Parts of xylene; 75 parts of titanium dioxide “R-61N” commercially available from SAKAI CHEMICAL INDUSTRY CO., LTD.; 30 parts of barium sulfate “B-34” commercially available from SAKAI CHEMICAL INDUSTRY CO., LTD.; 5 parts of talc “LMR-100” commercially available from FUJI TALC INDUSTRIAL CO., LTD.; 1 part of carbon black “MA-100” commercially available from Mitsubishi Chemical Corporation; and 0.8 part of a pigment dispersing agent “BYK-161” commercially available from BYK-Chemie GmbH were added and premixed with 55 parts of the polyester resin (a) consisting of the polyester resin (i) of the Preparation Example 1 and the polyester resin (ii) of the Preparation Example 4, as shown in the following Table 2. The mixture was added to a paint conditioner with glass beads. The mixture was dispersed at room temperature for 1 hour to give a pigment dispersed paste (particle size=no more than 5 μm; nonvolatile content=63%).

5 Parts of an epoxy resin “EPOTOHTO YD-172” (product of a reaction of a dimeric acid with a bisphenol A glycidyl ether; epoxy equivalent=650 g/eq) commercially available from Tohto Kasei Co., Ltd.; 30 parts of an imino group-containing melamine resin (methyl/butyl-mixed alkyl ether type melamine resin) “Cymel 202” commercially available from Mitsui Cytec Industries Inc.; 15 parts of an imino group-containing melamine resin (methyl/butyl-mixed alkyl ether type melamine resin) “Cymel 211” commercially available from Mitsui Cytec Industries Inc.; 0.5 part of benzoin “S-19”; 0.13 part of a surface conditioner “Resimix RL-4” commercially available from Mitsui Petrochemical Industries, LTD.; and 0.04 part of a silicone surface conditioner “BYK-344” commercially available from BYK-Chemie GmbH were added and mixed with 236 parts of the above-prepared pigment dispersed paste to give an intermediate coating composition. The unit “part(s)” (in the following Tables 2 and 3 as well) is/are based on the solid contents.

### Formation of Multi Layered Coating Film

A cationic electrodeposition coating composition (“POWERTOP V-50” commercially available from Nippon Paint Co., Ltd.) was electrodeposited on a dull steel plate (30 cm×40 cm×0.8 mm (thickness)) which had been subjected to a chemical treatment with zinc phosphate. The plate having an electrodeposition coating was baked at 160° C. for 30 minutes to give a cured film having thickness of about 20 μm.

The above-prepared intermediate coating composition (liquid) was diluted with a thinner (butyl acetate/ortho-hexyl alcohol=1/1 (as a basis of weight)) to 35 seconds/20° C. using No. 4 Ford cup. The coating composition was applied on the cured electrodeposition coating film of the plate with an air spray gun such that the resulting cured coating film had thickness of about 30 μm. After setting for 7 to 10 minutes, the plate was baked at 140° C. for 30 minutes.

Subsequently, a previously diluted waterborne type metallic color base coating composition (“AQUAREX 2000 silver metallic” commercially available from Nippon Paint Co., Ltd.) was applied thereto by a two-stage coating method with an external electrode type “meta-bel”, such that the resulting cured coating film had thickness of about 15 μm. 1.5 Minutes interval was settled between the coatings. After the second coating, the plate was subjected to 3 minutes setting and then preheating at 80° C. for 3 minutes.

An acid/epoxy curing system clear coating composition (“Macflow O-1800” commercially available from Nippon Paint Co., Ltd.) was diluted with a solvent S-100 (an aromatic hydrocarbon solvent commercially available from EXXON CORPORATION) to 28 seconds/20° C. using No. 4 Ford cup. The diluted coating composition was applied on the uncured base coating by an air spraying such that the resulting cured coating film had thickness of about 40 μm. After setting for 7 to 10 minutes, the panel was baked at 140° C. for 30 minutes to give a multi layered coating film.

Thus prepared multi layered coating film was evaluated according to the following evaluations.

### Measurement of Lowest Adhesion Strength

With respect to the above-prepared multi layered coating film, the lowest adhesion strength between the intermediate coating film and the base coating film thereon was measured with a CN-100 type SAICAS apparatus (manufactured by DAIPLA WINTES CO. LTD). As shown in FIG. 2, in advance of the measurement, the clear coating film and a part of the base coating film were scraped off to remain a boundary between the base coating film and the intermediate coating film. The thickness of the remained base coating film was 10 μm. The interlayer adhesion strength between the base coating film and the intermediate coating film was determined. Herein, a blade was cutting into the scraped area. Once the blade reached to the boundary between the base coating film and the intermediate coating film, i.e., 10 μm of cutting depth, the blade was only horizontally shifted and the horizontal scraping stress was measured (see FIG. 2, wherein scraping is indicated by an arrow). Among the found stress values, the “lowest adhesion strength” was determined (see FIG. 3). The results are shown in the following Tables 2 and 3.

### Chipping Resistance Test

300 g of Gravels (No. 6) were forced to be in collision with the multi layered coating film formed on the steel plate, as a test sample, with a gravelotester, KSS-1 (manufactured by Suga Test Instruments Co., Ltd.) [testing temperature=−20° C.; distance=35 cm; air pressure=0.5 MPa; angle=45°]. The plate was rinsed with water and then dried. An industrial adhesive tape (i.e., a gum tape commercially available from NICHIBAN CO., LTD.) was applied on the coating surface, and then pealed off. The peeled area of the coating surface was visually observed. Chipping was evaluated according to the following evaluation basis (chipping ranking). Chipping rankings 4 and 5 according to the following evaluation basis are superior in chipping resistance and applicable.

### Evaluation Basis

5: No peeling, wherein the peeled area percentage relative to the whole coating area is 0%.
4: Small peeled area and less frequency, wherein the peeled area percentage relative to the whole coating area is about 5%.
3: Small peeled area and no less frequency, wherein the peeled area percentage relative to the whole coating area is about 10%.
2: Large peeled area and high frequency, wherein the peeled area percentage relative to the whole coating area is about 30%.
1: Extremely large peeled area and high frequency, wherein the peeled area percentage relative to the whole coating area is about 50%.

### Examples 2 to 5 and Comparison Examples 1 to 5

According to the Example 1, an intermediate coating composition containing polyester resin (a) consisting of polyester resins (i) and (ii) as listed in the following Table 2 or 3 was prepared. A multi layered coating film was prepared according to the Example 1. The coating film was evaluated as described in Example 1. Evaluation results are shown in the following Tables 2 and 3.

TABLE 2

| | | Ex. 1 | Ex. 2 | Ex. 3 | Ex. 4 | Ex. 5 |
|---|---|---|---|---|---|---|
| Polyester | Prep. | 27.5 | | 33.0 | | |
| resin | Ex. 1 | | | | | |
| (i) | Prep. | | 27.5 | | | |
| | Ex. 2 | | | | | |
| | Prep. | | | | 27.5 | 27.5 |
| | Ex. 3 | | | | | |
| | Comp. | | | | | |
| | Prep. | | | | | |
| | Ex. 1 | | | | | |
| Polyester | Prep. | 27.5 | 27.5 | | 27.5 | |
| resin | Ex. 4 | | | | | |
| (ii) | Prep. | | | 22.0 | | 27.5 |
| | Ex. 5 | | | | | |
| | Comp. | | | | | |
| | Prep. | | | | | |
| | Ex. 2 | | | | | |

| | | | | | |
|---|---|---|---|---|---|
| Polyester resin ratio | 1/1 | 1/1 | 6/4 | 1/1 | 1/1 |
| [(i)/(ii)] | | | | | |
| Weight ratio of | 55/45 | 55/45 | 55/45 | 55/45 | 55/45 |
| polyester resin (a)/ | | | | | |
| imino group- | | | | | |
| containing melamine | | | | | |
| resin (c) | | | | | |
| [(a)/(c)] | | | | | |
| Lowest adhesion | 0.23 | 0.18 | 0.25 | 0.15 | 0.27 |
| strength (kN/m) | | | | | |
| Chipping rank | 5 | 5 | 4 or | 4 or | 4 |
| | | | 5 | 5 | |

TABLE 3

| | | Comp. | Comp. | Comp. | Comp. | Comp. |
|---|---|---|---|---|---|---|
| | | Ex. 1 | Ex. 2 | Ex. 3 | Ex. 4 | Ex. 5 |
| Polyester | Prep. | 27.5 | | | | |
| resin | Ex. 1 | | | | | |
| (i) | Prep. | | 27.5 | | | |
| | Ex. 2 | | | | | |
| | Prep. | | | | | |
| | Ex. 3 | | | | | |
| | Comp. | | | 27.5 | 33.0 | 27.5 |
| | Prep. | | | | | |
| | Ex. 1 | | | | | |
| Polyester | Prep. | | | 27.5 | | |
| resin | Ex. 4 | | | | | |
| (ii) | Prep. | | | | 22.0 | |
| | Ex. 5 | | | | | |
| | Comp. | 27.5 | 27.5 | | | 27.5 |
| | Prep. | | | | | |
| | Ex. 2 | | | | | |

| | | | | | |
|---|---|---|---|---|---|
| Polyester resin ratio | 1/1 | 1/1 | 1/1 | 6/4 | 1/1 |
| [(i)/(ii)] | | | | | |
| Weight ratio of | 55/45 | 55/45 | 55/45 | 55/45 | 55/45 |
| polyester resin (a)/ | | | | | |
| imino group- | | | | | |
| containing | | | | | |
| melamine | | | | | |
| resin (c) | | | | | |
| [(a)/(c)] | | | | | |
| Lowest adhesion | 0.10 | 0.13 | 0.28 | 0.30 | 0.32 |
| strength (kN/m) | | | | | |
| Chipping rank | 3 or | 3 or | 3 or | 3 or | 3 |
| | 4 | 4 | 4 | 4 | |

As shown in the Tables 2 and 3, the multi layered coating film according to the present invention includes the intermediate coating film formed with the present intermediate coating composition, which comprises (a) a polyester resin, (b) a bisphenol type epoxy resin and (c) an imino group-containing melamine resin, wherein the polyester resin (a) comprises the above-listed polyester resins (i) and (ii). The present multi layered coating film can provide an excellent chipping resistance. According to the chipping resistance test, the peeled area of the present multi layered coating film surface is none or small. On the other hand, the multi layered coating films of the Comparison Examples 1, 2 and 5 have inferior chipping rankings. These Comparison Examples employs an intermediate coating composition containing the polyester resin of the Comparison Preparation Example 2 having a number average molecular weight similar to that of the polyester resin (ii) and an acid ratio wherein the soft acid content is low. The multi layered coating films of the Comparison Examples 3, 4 and 5 also have inferior chipping rankings. These Comparison Examples employs an intermediate coating composition containing the polyester resin of the Comparison Preparation Example 1 having a number average molecular weight similar to that of the polyester resin (i) and an acid ratio wherein the rigid acid content is low.

### INDUSTRIAL APPLICABILITY

The present inventive intermediate coating composition comprises (a) a polyester resin, (b) a bisphenol type epoxy resin, and (c) an imino group-containing melamine resin. The polyester resin (a) comprises at least two polyester resins, each of which has an individual property, i.e., polyester resins (i) and (ii). Application of thus prepared intermediate coating composition can provide a formation of a multi layered coating film, which has an excellent chipping resistance in addition to excellent properties such as corrosion resistance, hiding ability to an undercoat, surface smoothness, and which has an excellent interlayer adhesions between an electrodeposition coating film and the intermediate coating film and between the intermediate coating film and a base coating film. Particularly, the multi layered coating film according to the present invention has a particularly excellent chipping resistance. The multi layered coating film is particularly suitable for a coating on an exterior body panel of a vehicle, such as automobile, which is used in the cold regions wherein the excellent chipping resistance is required.

### BRIEF DESCRIPTION OF THE DRAWINGS

FIG. 1 is a schematic view of SAICAS method measuring adhesion strength.

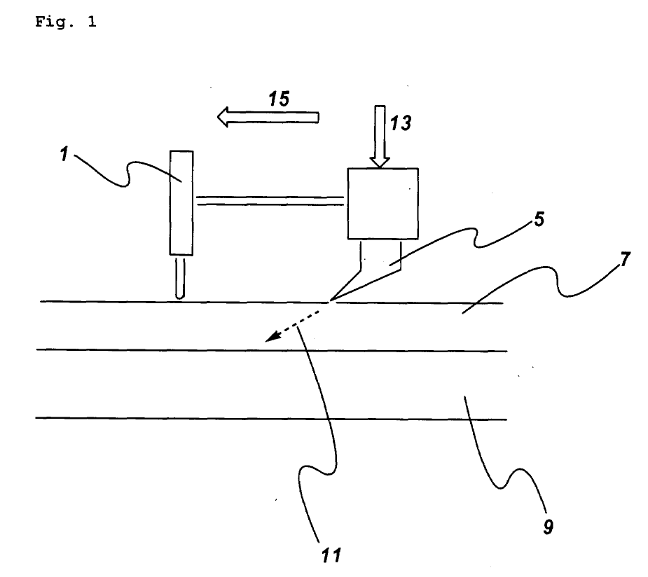

FIG. 2 is a schematic view of a multi layered coating film according to the present invention, which is subjected to a adhesion strength measurement.

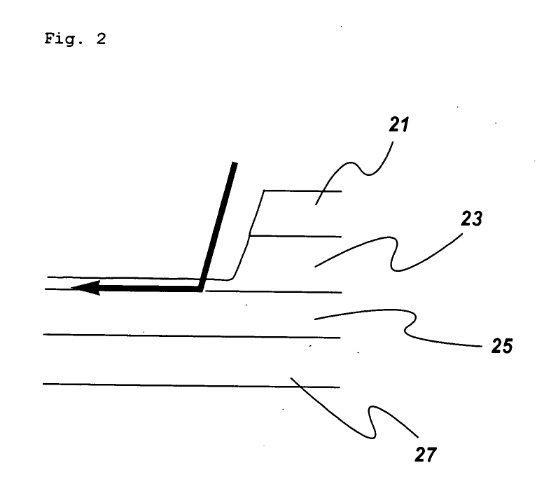

FIG. 3 is a schematic view of a concept of the lowest adhesion strength.

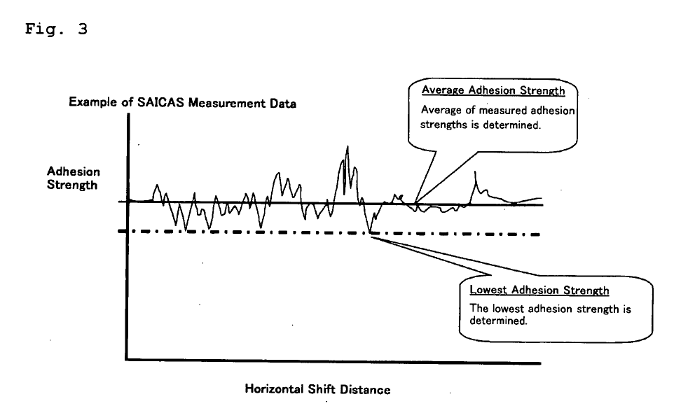

### EXPLANATION OF LETTERS OR NUMBERS

1: Vertical displacement gage
5: Blade
7: Coating film
9: Article
11: Cutting direction
13: Vertical load
15: Horizontal force
21: Clear coating film
23: Base coating film
25: Intermediate coating film
27: Electrodeposition coating film

1. An intermediate coating composition, which comprises
(a) 40 to 70% by weight of a polyester resin comprising a polyester resin (i) and a polyester resin (ii),
(b) 2.5 to 12.5% by weight of a bisphenol type epoxy resin, and
(c) 25 to 50% by weight of an imino group-containing melamine resin, each of which contents of the components (a), (b) and (c) is relative to weight of the resin solid contents in the composition,
wherein
a weight ratio of the polyester resin (a)/the imino group-containing melamine resin (c) [(a)/(c)] is within a range of 50/50 to 70/30, and wherein
the polyester resin (i) has a number average molecular weight of 2000 to 4000, and is prepared by a condensation polymerization of, at least, a polycarboxylic acid component and a polyalcohol component, wherein the polycarboxylic acid component comprises no less than 50% by weight of at least one of polycarboxylic acids selected from the group consisting of aromatic polycarboxylic acids, alicyclic polycarboxylic acids and anhydrides thereof, and
the polyester resin (ii) has a number average molecular weight of 1000 to 2000, and is prepared by a condensation polymerization of, at least, a polycarboxylic acid component and a polyalcohol component, wherein the polycarboxylic acid component comprises no less than 50% by weight of a straight or branched aliphatic polycarboxylic acid or an anhydride thereof.

2. The intermediate coating composition according to claim 1, wherein the bisphenol type epoxy resin (b) has an epoxy equivalent of 500 to 1500 g/eq, and the imino group-containing melamine resin (c) further has an alkyl ether group comprising a methyl group and a butyl group.

3. A method for producing a multi layered coating film comprising an intermediate coating film on an article, a base coating film thereon and a clear coating film thereon, which includes steps of
applying an intermediate coating composition on an article, heating and curing to form an intermediate coating film, and
applying a base coating composition and clear coating composition on the cured intermediate coating film, heating and curing to form a multi layered coating film,
wherein
the intermediate coating composition comprises
(a) 40 to 70% by weight of a polyester resin comprising a polyester resin (i) and a polyester resin (ii),
(b) 2.5 to 12.5% by weight of a bisphenol type epoxy resin, and
(c) 25 to 50% by weight of an imino group-containing melamine resin,
each of which contents of the components (a), (b) and (c) is relative to weight of the resin solid contents in the composition,
wherein
a weight ratio of the polyester resin (a)/the imino group-containing melamine resin (c) [(a)/(c)] is within a range of 50/50 to 70/30, and wherein the polyester resin (i) has a number average molecular weight of 2000 to 4000, and is prepared by a condensation polymerization of, at least, a polycarboxylic acid component and a polyalcohol component, wherein the polycarboxylic acid component comprises no less than 50% by weight of at least one of polycarboxylic acids selected from the group consisting of aromatic polycarboxylic acids, alicyclic polycarboxylic acids and anhydrides thereof, and
the polyester resin (ii) has a number average molecular weight of 1000 to 2000, and is prepared by a condensation polymerization of, at least, a polycarboxylic acid component and a polyalcohol component, wherein the polycarboxylic acid component comprises no less than 50% by weight of a straight or branched aliphatic polycarboxylic acid or an anhydride thereof.

4. The method according to claim 3, wherein the bisphenol type epoxy resin (b) has an epoxy equivalent of 500 to 1500 g/eq, and the imino group-containing melamine resin (c) further has an alkyl ether group comprising a methyl group and a butyl group.

5. The method according to claim 3, wherein the lowest adhesion strength is within a range of 0.15 to 0.27 kN/m on the coating boundary between the intermediate coating film and the base coating film thereon in the multi layered coating film.

6. A multi layered coating film which is obtainable by the method according to any one of claim 3.

7. The method according to claim 4, wherein the lowest adhesion strength is within a range of 0.15 to 0.27 kN/m on the coating boundary between the intermediate coating film and the base coating film thereon in the multi layered coating film.

8. A multi layered coating film which is obtainable by the method according to claim 4.

9. A multi layered coating film which is obtainable by the method according to claim 5.

10. A multi layered coating film which is obtainable by the method according to claim 7.
